(19) United States
(12) Patent Application Publication
(10) Pub. No.: US 2007/0292822 A1
(43) Pub. Date: Dec. 20, 2007

(54) Method for Production of Dental Prosthetics

(75) Inventor: Larry Stites, Tracy, CA (US)

Correspondence Address: CHOATE, HALL & STEWART LLP, TWO INTERNATIONAL PLACE, BOSTON, MA, 02110, US

(73) Assignee: MICRO DENTAL LABORATORIES, INC., Dublin, CA (US)

(21) Appl. No.: 11/670,102

(22) Filed: Feb. 1, 2007

Related U.S. Application Data
(60) Provisional application No. 60/764,400, filed on Feb. 1, 2006.

(51) Int. Cl. A61C 13/00

(52) U.S. Cl. 433/215

(57) ABSTRACT

A method of producing a dental prosthetic includes preparing a coping, preparing a restoration, and attaching the coping to the restoration at a temperature less than about 850° C.

This application claims priority to U.S. Provisional Application Ser. No. 60/764,400 filed Feb. 1, 2006, the contents of which are incorporated herein by reference.

### FIELD OF THE INVENTION

This invention relates to the production of dental restorations.

### BACKGROUND OF THE INVENTION

Dental restorations may be used to replace a tooth or a portion of a tooth. The restoration, e.g., a bridge, crown, or veneer, may be fastened directly to the tooth or to a prosthetic base that provides mechanical support and continuity with the jaw. The ceramic restoration may be attached to the support or may include a metallic or ceramic coping that is attached to the interior portion of the prosthetic.

Where the coping and the restoration (e.g., the portion that functions as the exterior of the tooth) are affixed to one another by firing, differences in the coefficient of thermal expansion can cause cracking or residual stresses in the final prosthetic. As a result, it is desirable to have alternative methods of fabricating dental restorations.

### BRIEF DESCRIPTION OF THE DRAWING

The invention is described with reference to the several figures of the drawing, in which,

FIG. 1A is a picture of an exemplary coping mounted on an exemplary die according to an embodiment of the invention.

FIG. 1B is a picture of an exemplary crown mounted on the coping depicted in FIG. 1A.

FIG. 1C is a picture of an exploded view of the die, coping, and crown shown in FIG. 1B.

FIG. 1D is a picture of the interior of the crown shown in FIG. 1B, with the coping attached.

### DETAILED DESCRIPTION OF CERTAIN PREFERRED EMBODIMENTS

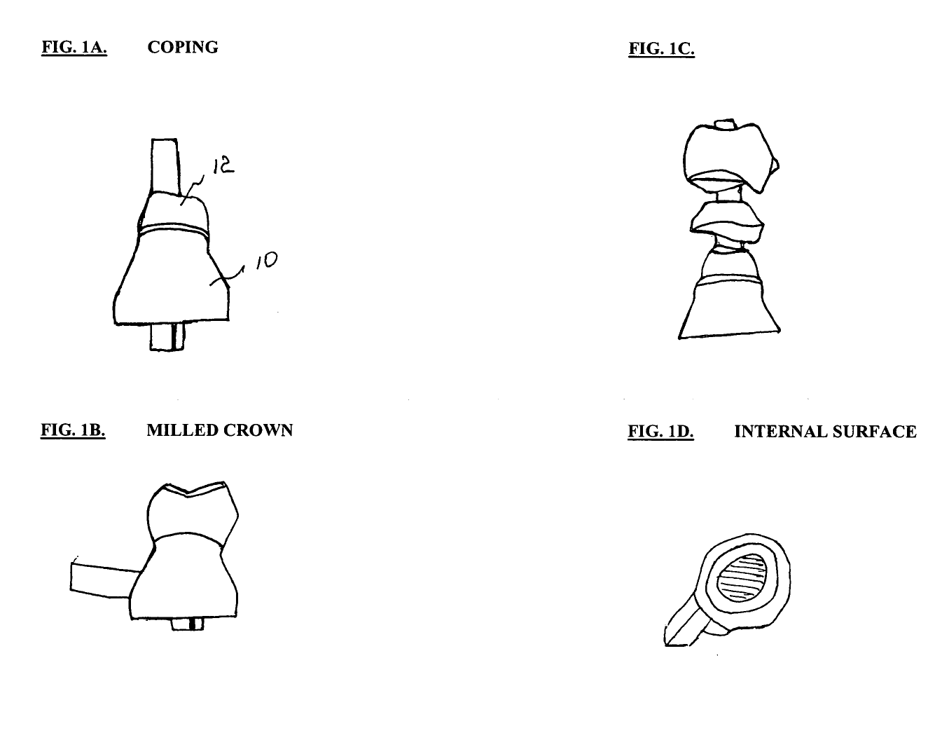

In one embodiment, a dental restoration, e.g., crown (front and lateral teeth), inlay, overlay, onlay, partial crown, fixation, implant abutment, or veneer, is produced. FIG. 1A shows a die 10 with a coping 12 mounted thereon. The die may be fabricated using standard dental prosthetic fabrication techniques. For example, an impression or an electronic file may be produced of the patient's teeth or the portion of the patient's teeth where the restoration will be mounted. The impression is then used to produce a mold. The portion of the mold where the restoration will be mounted is trimmed. After trimming, the occlusal portion of the mold is properly shaped to receive the prosthetic. The patient's teeth may have been trimmed to achieve this shape, or the mold may be shaped to receive a bridge (e.g., as a pontic).

The coping is then fabricated. The coping may be fabricated by hand, using a mold (e.g., through lost wax or other techniques) or using CAD/CAM techniques. Alternative techniques include 3D printing techniques such as those discussed in European patent application 0 431 924, U.S. Pat. Nos. 5,902,441, 5,490,962, 5,864,161, and international patent applications 94/19112, 97/26302 and 98/51747. Other techniques for fabricating copings known to those of skill in the art may also be used. The coping may be fabricated from metals or ceramics. Exemplary metals include but are not limited to gold and zirconium and alloys of these with each other or other metals such as but not limited to platinum, palladium, nickel, chromium, iron, aluminum, molybdenum, beryllium, copper, magnesium, cobalt, and tin, for example, alloys employed by GALVANO™ and CAPTEK™ (Altamonte Springs, Fla.), and alloy mixtures. Exemplary ceramics include zirconia, lithium disilicate, alumina, reinforced Lucite, and feldspathic ceramics, for example, nantholean feldspar. Alternative materials known to those of skill in the art may also be employed.

The coping is then processed using standard dental prosthetic processing techniques to provide an opaque, liner, or shaded base. The die, with the opaque coated-coping mounted thereon, is then scanned, for example, using CEREC™ (Sirona Dental Systems GmbH, Bensheim, Germany) or any other 3D scanning software known to those of skill in the art. This produces a datafile that can describe the interior of the restoration. The same or alternative computer-aided design techniques may be used to prepare a datafile describing the exterior (e.g., biting surface) of the restoration. For example, the biting surface may be designed using software or prepared by hand and scanned.

The restoration may then be formed using any of the machine-aided techniques described above (FIG. 1B). For example, the restoration may be milled or machined using CAD/CAM techniques or 3D printing techniques. Any material that is used for dental restorations, including the ceramics described above for use with copings, may be employed, for example, Ivoclar ProCad™, and ceramics manufactured by Vita, for example, Vitabloc™ Mark II, and composites, for example, Paradigm™ from 3M-Espe, and other dental ceramics and composites known to those skilled in the art. The fit of the restoration on the coping and the die is then checked, and the restoration may be trimmed if necessary (see FIG. 1C). Material may be added to the restoration using standard dental prosthetic manufacturing techniques. For example, the restoration may be customized using porcelain or composite materials. In some embodiments, the restoration may be stained and glazed or cut back and stained.

The coping is then attached to the restoration, for example, by cementing, adhesive bonding, cohesive bonding, glues, or low temperature (e.g., about 600°-850° C.) fusing pastes (FIG. 1D). In some embodiments, the coping is attached at room temperature or at an ambient temperature. Cohesive bonds are formed by agents that penetrate past the surface of both materials that are being attached; in adhesive bonding, at least one surface is not penetrated by the bonding agent. Exemplary materials that may be used to attach the coping and the restoration include but are not limited to RelyX™ from 3M-Espe, Panavia™ from Kuraray Dental, Calibra™ from Dentsply, Panavia™ 21 from Kuraray Dental, and Duceram™ LFC from Degudent. Light curing, self-curing, and dual curing materials may all be employed. The use of light curing materials depends on the thickness and translucency of the overlying material and may be more appropriate for metal-free to metal-free prosthetics.

The use of room temperature, low temperature methods (e.g. lower than the temperatures often used to fire ceramics, between about 850° C. and 950° C.), enables a variety of additional techniques to be used in the preparation of dental restorations. For example, the restoration and the coping may be attached to one another by the dentist just prior to disposal in the patient's mouth. In some embodiments, the coping, the restoration, or both may be prepared by the dentist or by a dental laboratory. Exemplary embodiments include the preparation of metal-free and metal-on-ceramic restorations. The fabrication of the coping and/or the restoration may include hand-molding of various components or may be entirely automated.

In another embodiment, the invention is a kit for preparing a dental prosthetic for a patient, including a coping and an adhesive material for attaching the coping to a restoration at a temperature less than 850° C. The kit may further include the restoration and/or a ceramic material appropriate for use in the fabrication of the restoration.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of producing a dental prosthetic, comprising:
preparing a coping;
preparing a restoration; and
attaching the coping to the restoration at a temperature less than about 850° C.

2. The method of claim 1, wherein the temperature is ambient temperature.

3. The method of claim 1, wherein preparing a coping, preparing a restoration, or both, comprise using computer-aided design/computer-aided manufacturing (CAD/CAM) techniques

4. The method of claim 1, wherein the coping is prepared from a metal or a ceramic.

5. The method of claim 1, wherein the coping is prepared by hand.

6. The method of claim 5, wherein preparing the restoration comprises:
scanning the coping; and
using a computer-operated device to mill the restoration from a solid block or print a form in the shape of the restoration.

7. The method of claim 1, wherein the temperature is between about 600° C. and about 850° C.

8. The method of claim 1, wherein the temperature is ambient temperature.

9. The method of claim 1, wherein preparing a coping comprises preparing the coping by hand or by using a computer-operated device.

10. A kit for preparing a dental prosthetic for a patient, comprising:
a coping; and
an adhesive material for attaching the coping to a restoration at a temperature less than 850° C.

11. The kit of claim 10, further comprising the restoration.

12. The kit of claim 10, further comprising a ceramic material appropriate for use in the fabrication of the restoration.

13. The kit of claim 10, wherein the temperature is between about 600° C. and about 850° C.

14. The kit of claim 10, wherein the temperature is ambient temperature.

15. A method of producing a dental prosthetic, comprising:
providing a coping;
providing a restoration; and
attaching the coping to the restoration at a temperature less than about 850° C.

16. The method of claim 15, wherein providing a coping comprises manufacturing the coping by hand or using a computer-operated device.

17. The method of claim 15, wherein providing a coping comprises using CAD/CAM techniques to manufacture the coping.

18. The method of claim 15, wherein providing the restoration comprises:
scanning the coping; and
using a computer-operated device to mill the restoration from a solid block or print a form in the shape of the restoration.

19. The method of claim 15, wherein the coping is fabricated from a metal or a ceramic.

20. The method of claim 15, wherein the temperature is between about 600° C. and about 850° C.

21. The method of claim 15, wherein the temperature is ambient temperature.
